(19) United States
(12) Patent Application Publication
(10) Pub. No.: US 2011/0081933 A1
(43) Pub. Date: Apr. 7, 2011

(54) APPARATUS AND METHOD FOR TRANSMITTING/RECEIVING SIGNAL IN WIRELESS COMMUNICATION SYSTEM

(75) Inventors: Sung-jin SUH, Seoul (KR); Kyoungmin PARK, Goyang-si (KR)

(73) Assignee: PANTECH CO., LTD., Seoul (KR)

(21) Appl. No.: 12/899,032

(22) Filed: Oct. 6, 2010

(30) Foreign Application Priority Data
Oct. 6, 2009 (KR) 10-2009-0094869

(51) Int. Cl. H04B 7/00

(52) U.S. Cl. 455/509

(57) ABSTRACT

Disclosed are apparatuses and methods for signal transmission/reception between a user equipment (UE) and a base station (BS) or cell in a wireless communication system in which a position of a US may be determined by identifying according to a positioning reference signal (PRS) pattern. By a method of transmitting PRSs using a more effective and efficient muting method, it is possible to reduce interference between multiple base stations that simultaneously transmit a same PRS pattern.

### CROSS-REFERENCE TO RELATED APPLICATION

This application claims priority from and the benefit under 35 U.S.C. §119(a) of Korean Patent Application No. 10-2009-0094869, filed on Oct. 6, 2009, which is hereby incorporated by reference for all purposes as if fully set forth herein.

### BACKGROUND

1. Field

Exemplary embodiments of the present invention relate to an apparatus and a method for transmitting and receiving signals between a User Equipment (UE) and a Base Station (BS) in a wireless communication system.

2. Discussion of the Background

In a WCDMA (Wideband Code Division Multiple Access) system, positioning methods for various positioning services and for providing location information for communication systems are generally based on three types of methods, which include: 1) a cell coverage-based positioning method; 2) an OTDOA-IPDL (Observed Time Difference of Arrival-Idle Period Downlink) method; and 3) a network assisted GPS (Global Positioning System) method. These methods are complementary to each other rather than competitive to each other, and are exploited properly for their own purposes, respectively.

Among these three methods, the OTDOA (Observed Time Difference of Arrival) method is based on a measurement of the relative arrival time of reference signals, or pilot signals, from different base stations or cells. For the calculation of a location, a UE (User Equipment) or MS (Mobile Station) receives reference signals (or pilot signal) from at least three different base stations or cells. In addition, in order to make the OTDOA positioning measurement easier and to avoid the near-far problem, the WCDMA standards include IPDL (Idle Periods in Downlink). During one Idle Period of the WCDMA standards, a UE (or MS) is required to be capable of receiving a reference signal (or pilot signal) from an adjacent base station or cell, even when a reference signal (or pilot signal) transmitted with the same frequency bandwidth from a current serving base station or serving cell to which the UE currently belongs is strong.

The LTE (Long Term Evolution) system, which has been developed from the WCDMA of the 3GPP (3^{rd} Generation Partnership Project), is based on the OFDM (Orthogonal Frequency Division Multiplexing), which is different from the asynchronous CDMA system of the WCDMA. As is in the current WCDMA system, positioning based on the OTDOA method is considered in the new LTE system also. To this end, current discussion for the LTE system includes employment of a method in which a data region is punctured with a certain period in a normal subframe and/or an MBSFN (Multicast Broadcast Single Frequency Network) subframe, and a reference signal for positioning (positioning reference signal) is transmitted in the punctured area. That is, for positioning in the LTE, which is a next-generation communication method, it is necessary to reconsider a method for transmitting a positioning reference signal and the construction of the positioning reference signal in the new resource positioning structure, which has changed communication bases, such as the multiplexing method and the access method, although it is based on the OTDOA method in the existing WCDMA. Further, the development of communication systems, including an increasing speed in the movement of a UE, a changing interference environment between base stations, and an increasing complexity of the communication environment, requires a more exact positioning method.

### SUMMARY

Additional features of the invention will be set forth in the description which follows, and in part will be apparent from the description, or may be learned by practice of the invention.

An exemplary embodiment of the present invention discloses a method for signal communication of a wireless communication system, the method including: allocating N consecutive downlink subframes for a positioning reference signal (PRS) to each period of a plurality of periods for at least one base station, the PRS being allocated as large as a PRS bandwidth of a total bandwidth; by the at least one base station, transmitting the PRS or muting the PRS to a terminal in the N consecutive downlink subframes of at least one period of the plurality of periods; by the terminal, receiving at least one of the transmitted PRS or the muted PRS from the at least one base station in the N consecutive downlink subframes of the at least one period of the plurality of periods; and by the terminal, calculating at least one difference of arrival time of the transmitted PRS or the muted PRS from the at least one base station, wherein the N, the PRS bandwidth, and the period of the at least one base station are delivered to the terminal from the at least one base station, and wherein transmitting the PRS or muting the PRS includes transmitting all PRS or muting all PRS in the N consecutive downlink subframes of the at least one period of the plurality of periods.

An exemplary embodiment of the present invention discloses a method for signal transmission of a wireless communication system, the method including: allocating N consecutive downlink subframes for a positioning reference signal (PRS) to each period of a plurality of periods for at least one base station, the PRS being allocated as large as a PRS bandwidth of a total bandwidth; and by the at least one base station, transmitting the PRS or muting the PRS to a terminal in the N consecutive downlink subframes of at least one period of the plurality of periods, wherein the N, the PRS bandwidth, and the period of the at least one base station are delivered to the terminal from the at least one base station, and wherein transmitting the PRS or muting the PRS includes transmitting all PRS or muting all PRS in the N consecutive downlink subframes of the at least one period of the plurality of periods.

An exemplary embodiment of the present invention discloses a method for signal receiving of a wireless communication system, the method including: by the terminal, receiving at least one of a transmitted positioning reference signal (PRS or a muted PRS in N consecutive downlink subframes of at least one period of a plurality of periods from at least one base station, the PRS being allocated as large as a PRS bandwidth of a total bandwidth; and by the terminal, calculating at least one difference of arrival time of the transmitted PRS or the muted PRS from the at least one base station, wherein the N, the PRS bandwidth, and the period of the at least one base station are delivered to the terminal from the at least one base station, and wherein transmitting the PRS or muting the PRS includes transmitting all PRS or muting all PRS in bandwidth in the N consecutive downlink subframes of the at least one period of the plurality of periods.

An exemplary embodiment of the present invention discloses a wireless communication system, including: at least one base station to allocate N consecutive downlink subframes for a positioning reference signal (PRS) to each period of a plurality of periods for at least one base station and to transmit the PRS or mute the PRS to a terminal in the N consecutive downlink subframes of at least one period of the plurality of periods, the PRS being allocated as large as a PRS bandwidth of a total bandwidth; and the terminal to receive at least one of the transmitted PRS or the muted PRS in the N consecutive downlink subframes of the at least one period of the plurality of periods from the at least one base station and to calculate at least one difference of arrival time of the transmitted PRS or the muted PRS from the at least one base station, wherein the N, the PRS bandwidth, and the period of the at least one base station are delivered to the terminal from the at least one base station, and wherein transmitting the PRS or muting the PRS includes transmitting all PRS or muting all PRS in the N consecutive downlink subframes of the at least one period of the plurality of periods.

An exemplary embodiment of the present invention discloses a signal transmission apparatus, including: a resource element mapper to map complex modulation symbols of each antenna port to a corresponding resource element; and a position reference signal (PRS) resource allocation unit to allocate N consecutive downlink subframes for a PRS to each period of a plurality of periods for at least one base station; and to transmit the PRS or mute the PRS to a terminal in the N consecutive downlink subframes of the at least one period of the plurality of periods, the PRS being allocated as large as a PRS bandwidth of a total bandwidth, wherein the N, the PRS bandwidth, and the period of the at least one base station are delivered to the terminal from the at least one base station, and wherein transmitting the PRS or muting the PRS includes transmitting all PRS or muting all PRS in the N consecutive downlink subframes of the at least one period of the plurality of periods.

An exemplary embodiment of the present invention discloses a signal reception apparatus, including: a reception processing unit to receive at least one of a transmitted positioning reference signal (PRS) or a muted PRS in N consecutive downlink subframes of at least one period of a plurality of periods from the at least one base station, the PRS being allocated as large as a PRS bandwidth of a total bandwidth; and a control unit to calculate at least one difference of arrival time of the transmitted PRS or the muted PRS from the at least one base station, wherein the N, the PRS bandwidth, and the period of the at least one base station are delivered to the terminal from the at least one base station, and wherein transmitting the PRS or muting the PRS includes transmitting all PRS or muting all PRS in the N consecutive downlink subframes of the at least one period of the plurality of periods.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a wireless communication system according to an exemplary embodiment of the present invention.

FIG. 2 and FIG. 3 illustrate patterns of positioning reference signals tentatively determined in a current LTE system for one subframe, when a normal CP (cyclic prefix) is added in a normal subframe and when an extended CP is added in a normal subframe, respectively.

FIG. 4 illustrates a transmission apparatus for generating and transmitting a PRS pattern according to an exemplary embodiment of the present invention.

FIGS. 5 to 10 illustrate methods of transmitting PRSs in muting patterns for N and K according to exemplary embodiments of the present invention.

FIG. 11 illustrates an arrangement of BSs (cells) divided into three groups according to the muting pattern for transmission of PRSs according to an exemplary embodiment of the present invention.

FIG. 12 is a flowchart illustrating a method of positioning of a UE according to an exemplary embodiment of the present invention.

FIG. 13 is a block diagram illustrating a signal receiving apparatus of a UE according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Like elements, features, and structures are denoted by like reference numerals throughout the drawings and the detailed description, and the size and proportions of some elements may be exaggerated in the drawings for clarity and convenience.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

Further, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

The present disclosure provides a system and a method for signal transmission in a wireless communication system, which can additionally identify base stations, which transmit positioning reference signals with a same positioning reference signal pattern, by identifying each subframe of transmitting the positioning reference signal for each base station.

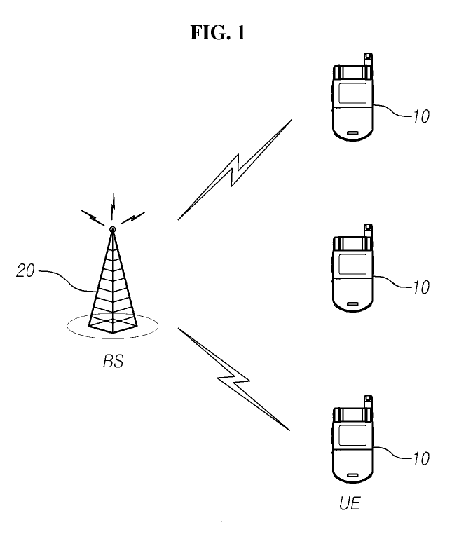

FIG. 1 is a block diagram illustrating a wireless communication system according to an exemplary embodiment of the present invention.

The wireless communication system is arranged in order to provide various communication services, such as voice, packet data, etc.

Referring to FIG. 1, a wireless communication system includes a UE (User Equipment) 10 and a BS (Base Station) 20. The UE 10 and the BS 20 use various power allocation methods as described below.

As used herein, the UE 10 has an inclusive meaning referring to a user terminal in a wireless communication, and should be construed as a concept including not only a UE in WCDMA, LTE, HSPA (High Speed Packet Access), etc. but also a UT (User Terminal), SS (Subscriber Station), and wireless device and an MS (Mobile Station) in GSM (Global System for Mobile Communication).

The BS 20 may be a cell and generally refers to a fixed station communicating with the UE 10, and may be called by another name, such as Node-B, eNB (evolved Node-B), BTS (Base Transceiver System), or AP (Access Point).

That is, as used herein, the BS 20 should be construed as having an inclusive meaning indicating an area covered by a BSC (Base Station Controller) of the CDMA, a Node B of the WCDMA, etc., and may correspond to one of various coverage areas, which include a mega cell, a macro cell, a micro cell, a pico cell, femto cell, etc.

The UE 10 and the BS 20 are not limited to specifically expressed terms or words and inclusively indicate two transmitting and receiving agents used for implementation of the technology described herein.

There is no limit in the multiple access methods applicable to a wireless communication system. That is, various multiple access methods, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA, can be applied to the wireless communication system. For example, the wireless communication system may be an OFDM-based wireless communication system, which includes at least one BS and at least one UE, wherein each of the BS and the UE may include at least one antenna.

For uplink transmission and downlink transmission, it is possible to use either a TDD (Time Division Duplex) method using different times for transmission or an FDD (Frequency Division Duplex) method using different frequencies for transmission.

Exemplary embodiments of the present invention can be applied to resource allocation in the asynchronous wireless communication, which is evolving to the LTE (Long Term Evolution) and the LTE-A (LTE-advanced) through the GSM, the WCDMA, and the HSPA, and resource allocation in the synchronous wireless communication, which is evolving to the CDMA, the CDMA-2000, and the UMB. Aspects of the present invention shall not be restrictively construed based on a particular wireless communication field and shall be construed to include all technical fields.

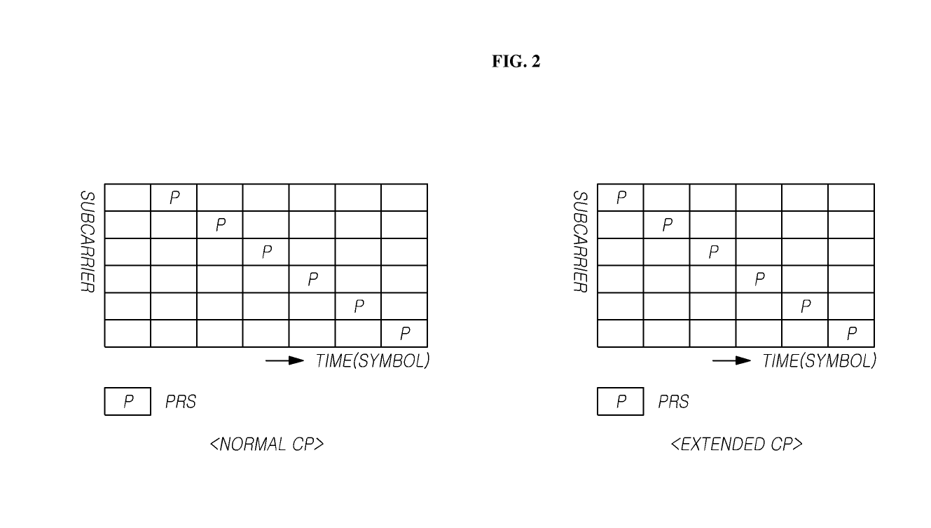

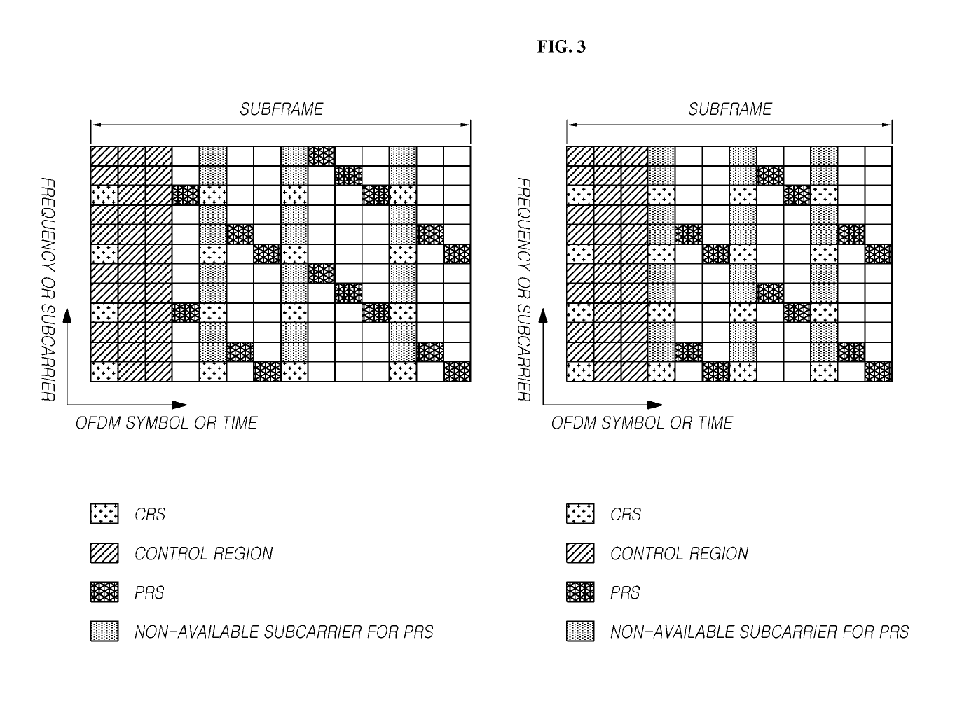

FIG. 2 and FIG. 3 illustrate patterns of positioning reference signals tentatively determined in a current LTE system for one subframe, when a normal CP (cyclic prefix) is added in a normal subframe and when an extended CP is added in a normal subframe, respectively.

A basic positioning reference signal pattern is formed in a ½ resource block configured by two slots and six subcarriers according to a particular sequence. An example of the used particular sequence is {0, 1, 2, 3, 4, 5}. Further, the two slots in the ½ resource block correspond to two time slots included in a subframe for positioning (i.e., a positioning subframe). Now, a method for forming a basic positioning reference signal pattern by the particular sequence will be described.

When the particular sequence is given as

f(i)={f(0), f(1), f(2), f(3), f(4), f(5)}={0, 1, 2, 3, 4, 5}, a positioning reference signal is formed at a subcarrier position in the frequency domain corresponding to the first value of the sequence from the last symbol in each of the two slots. That is, in the case of the last symbol, since the first value of the sequence is 0, a positioning reference signal is formed at the 0th subcarrier position. Next, in the second symbol from the last, a positioning reference signal is formed at the subcarrier position on the frequency domain corresponding to the second value of the sequence. That is, in the case of the second symbol from the last, since the second value of the sequence is 1, a positioning reference signal is formed at the 1st subcarrier position. In the same manner, positioning reference signals are formed at subcarrier positions in the frequency domain corresponding to sequence values up to the sixth symbol from the last in each of the two slots.

Referring to FIG. 3, in the generated positioning reference signal pattern, the control regions, such as PDCCH (Physical Downlink Control Channel), PHICH (Physical Hybrid-ARQ Indicator Channel), and PCFICH (Physical Control Format Indicator Channel), the symbol axis in which CRSs (Cell-specific Reference Signals) exist, and REs (Reference elements) in which PSSs (Primary Synchronization Signals), SSSs (Secondary Synchronization Signals), and BCHs (Broadcast Channels) exist, are punctured so that they are excluded from the basic positioning reference signal pattern.

The process of forming the basic positioning reference signal pattern as described above can be expressed by the following equations.

If ν is a value for defining positions of different Positioning Reference Signals (PRSs) in the frequency domain and the total number of OFDM symbols in each slot in the downlink is N_{symb}^{DL}, a basic positioning reference signal pattern for a corresponding 1^{st} OFDM symbol in each slot is formed according to Equation (1) defined below.

$$\begin{matrix}v = 5 - l + {N}_{CP} & \\ l = {N}_{symb}^{DL} - i for i = 1 , 2 , 4 , … , 4 + ( {n}_{5} mod 2 ) + {N}_{CP} & \\ {N}_{CP} = \{ \begin{matrix}1 & for normal CP \\ 0 & for extended CP\end{matrix} & ( 1 )\end{matrix}$$

In Equation (1), N_{symb}^{DL} has a value of 7 for a normal CP or 6 for an extended CP, and (n, mod 2) has a value of 0 for an even slot or 1 for an odd slot. Therefore, from equation (1), l can be defined by

$$l = \{ \begin{matrix}2 , 3 , 5 , 6 & if {n}_{5} mod 2 = 0 and {N}_{CP} = 1 \\ 1 , 2 , 3 , 5 , 6 & if {n}_{5} mod 2 = 1 and {N}_{CP} = 1 \\ 2 , 4 , 5 & if {n}_{5} mod 2 = 0 and {N}_{CP} = 0 \\ 1 , 2 , 4 , 5 & if {n}_{5} mod 2 = 1 and {N}_{CP} = 0.\end{matrix}$$

The basic positioning reference signals formed in the ½ resource block including six subcarriers and two slots configuring one subframe are allocated up to the system bandwidth along the frequency axis and allocated to N subframes repeatedly with a particular period along the time axis.

For example, if the system bandwidth is 10 Mhz, the frequency axis includes a total of 50 Resource Blocks (RBs). Therefore, the basic positioning reference signal pattern formed in the ½ Resource Block (RB) is repeated 100 times along the frequency axis. If the total number of RBs corresponding to the downlink system bandwidth is N_{RB}^{DL}, the basic positioning reference signal pattern is repeated 2·N_{RB}^{DL} times in total.

When the basic positioning reference signals are allocated to N subframes repeatedly with a particular period along the time axis, the basic positioning reference signals are distributed in a time-varying manner depending on the Subframe Number (SFN) and the cell-specific information of each cell, such as PCI (Physical Cell Identity), differently from the frequency axis. To this end, by using ν as a value for defining positions of the different positioning reference signals in the frequency domain according to the SFN and the cell-specific information, and using ν_{shift} as a value corresponding to the variance shifted along the frequency axis, the positions of the subcarriers, in which the PRSs are formed in each symbol, are equally cyclic-shifted by ν_{shift}.

For the k^{th} subcarrier in the entire system bandwidth including N_{RB}^{DL}N_{sc}^{RB} subcarriers, the above-described process can be expressed by Equation (2) below. In Equation (2), N_{RB}^{DL} refers to the number of total resource blocks corresponding to the downlink system bandwidth, and N_{sc}^{RB} refers to the number of subcarriers in one resource block. The k^{th} subcarrier defined by Equation (2) corresponds to a normal subframe serving as a positioning subframe.

k=6m+(ν+ν_{shift})mod 6

m=0, 1, . . . 2·N_{RB}^{DL}−1 (2)

In equation (2), ν corresponds to a value defining positions of the different positioning reference signals in the frequency domain as described above, and ν_{shift} corresponds to a shift variance by which the positions of the subcarriers, in which the PRSs are formed in each symbol according to the SFN and the cell-specific information, are equally cyclic-shifted. Further, ν_{shift} may have a value corresponding to a remainder after dividing a value generated by a function of the SFN and the cell-specific information by 6, which is a total possible frequency shift value. Especially, ν_{shift} may be obtained through a computation process in which one or more pseudo-random sequence values are first obtained by a function of positioning subframe numbers from a pseudo-random sequence created with the cell-specific information, such as PCI (Physical Cell Identity), as an initial value, the obtained pseudo-random sequence values are multiplied by a constant and are then summed, and then the sum is divided by 6, which is a total possible frequency shift value, so that the remainder of the division is obtained as ν_{shift}. This computation process can be expressed by Equation (3) below.

$${v}_{shift} = f ( {n}_{subframe} , {N}_{cell}^{ID} ) \to {v}_{shift} = ( {\sum }_{i}^{ } {a}^{i} \cdot c ( f ( {n}_{subframe} , i ) ) ) mod 6 \qquad ( 3 )$$

In Equation (3), N_{Cell}^{ID} indicates a PCI (Physical Cell ID) and 0≦N_{Cell}^{ID}<504; α indicates a constant; C(i) indicates a pseudo-random sequence; and Cᵢₙᵢₜ is an initial value of C, which is initialized at every subframe for positioning, wherein Cᵢₙᵢₜ=N_{Cell}^{ID}.

The processes as described above can be expressed using equations as follows. That is, a PRS (positioning reference signal) sequence f_{l,n}_{_{S}}(m) mapped to a complex-valued modulation symbol α_{k,l}^{(p)} obtained through a modulation into a complex value, which is used as a positioning reference symbol for an antenna port p at the nₛ^{th} slot, can be expressed by Equation (4) below.

$$\begin{matrix}{a}_{k , l}^{( p )} = {r}_{l , {n}_{s}} ( {m}^{′} ) & \\ k = 6 m + ( v + {v}_{shift} ) mod 6 & \\ l = {N}_{symb}^{DL} - i for i = 1 , 2 , 4 , … , 4 + ( {n}_{5} mod 2 ) + {N}_{CP} & \\ m = 0 , 1 , … , 2 \cdot {N}_{RB}^{DL} - 1 & \\ {m}^{t} = m + {N}_{RB}^{max , DL} - {N}_{RB}^{DL} & ( 4 ) \\ {N}_{CP} = \{ \begin{matrix}1 & for normal CP \\ 0 & for extended CP\end{matrix} & \end{matrix}$$

From Equation (4), l can be defined by

$$l = \{ \begin{matrix}2 , 3 , 5 , 6 & if {n}_{5} mod 2 = 0 and {N}_{CP} = 1 \\ 1 , 2 , 3 , 5 , 6 & if {n}_{5} mod 2 = 1 and {N}_{CP} = 1 \\ 2 , 4 , 5 & if {n}_{5} mod 2 = 0 and {N}_{CP} = 0 \\ 1 , 2 , 4 , 5 & if {n}_{5} mod 2 = 1 and {N}_{CP} = 0.\end{matrix}$$

In Equation (4), ν and ν_{shift}, which are values for defining positions of the different positioning reference signals in the frequency domain, can be defined by Equation (5) below. Further, ν_{shift} corresponds to a value specified to the cell-specific information and the positioning subframe number.

$$\begin{matrix}v = 5 - l + {N}_{CP} & \\ {v}_{shift} = f ( {n}_{subframe} , {N}_{cell}^{ID} ) \to {v}_{shift} = ( {\sum }_{i}^{ } {a}^{i} \cdot c ( f ( {n}_{subframe} , i ) ) ) mod 6 & ( 5 )\end{matrix}$$

In Equation (5), n_{subframe} refers to a positioning subframe number, and Cᵢₙᵢₜ indicates an initial value of C and is initialized at every subframe for positioning, wherein Cᵢₙᵢₜ=N_{Cell}^{ID} in a pseudo-random sequence C(i).

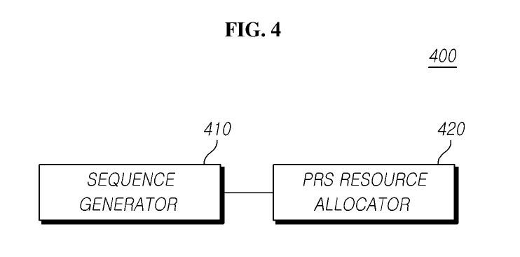

FIG. 4 illustrates a transmission apparatus to generate and transmit a PRS pattern according to an exemplary embodiment of the present invention.

Referring to FIG. 4, the transmission apparatus 400 to generate and transmit a PRS (Positioning Reference Signal) pattern includes a sequence generator 410 and a PRS resource allocator 420. The sequence generator 410 generates a PRS sequence according to the above-described manner. The PRS resource allocator 420 allocates PRSs formed according to the PRS sequence generated by the sequence generator 410 to resource elements according to a PRS pattern and a muting pattern, which will be described below in more detail. Then, the PRSs allocated to the resource elements are multiplexed with a BS transmission frame. As used herein, the PRS pattern refers to a transmission pattern of PRSs defined in a single subframe, and the muting pattern refers to a PRS transmission pattern based on each subframe, which includes a definition for the PRS pattern.

In resource allocation for the PRS, the PRS resource allocator 420 allocates resources to OFDM symbols (x-axis) and subcarriers (y-axis) according to a rule, and multiplexes the resources with the BS transmission frame at a frame time.

Hereinafter, a signal generation structure of a downlink physical channel of a wireless communication system, to which embodiments of the present invention are applied, will be described with reference to FIG. 4. In the signal generation structure of a downlink physical channel of a wireless communication system according to exemplary embodiments of the present invention, other elements may be omitted or added, or may be changed to or replaced by still other elements.

In the downlink, bits input in the form of code words after being channel-coded are scrambled by a scrambler, and are then input to a modulation mapper. The modulation mapper modulates the scrambled bits into complex modulation symbols, and a layer mapper maps the complex modulation symbols to one or more transmission layers. Thereafter, a precoder precodes the complex modulation symbols on each transmission channel of an antenna port. Then, a resource element mapper maps the complex modulation symbols of each antenna port to corresponding resource elements. The PRS resource allocator 420 generates a positioning reference signal pattern from the sequence generated by the sequence generator 410 and maps positioning reference signals according to the positioning reference signal pattern.

That is, in the wireless communication system 400, the PRS resource allocator 420 allocates the PRSs, which have been generated according to a particular positioning reference signal sequence and then processed by at least one device, to resource elements corresponding to resources, at which particular OFDM symbols (time axis) and subcarriers (frequency axis) are located, according to the positioning reference signal pattern formed according to a sequence, and then multiplexes them with the BS transmission frame at a predetermined frame time.

Existing reference signals (RSs), control signals, and data input from the precoder are allocated to resource elements corresponding to resources, at which particular OFDM symbols (time axis) and subcarriers (frequency axis) are located by the resource element mapper. The resource element mapper includes a device for performing a special function (for example, for forming and mapping a positioning reference signal pattern) added in order to allocate the PRSs to the resource elements, which corresponds to a PRS mapping unit.

Thereafter, an OFDM signal generator generates a complex time domain OFDM signal for each antenna. This complex time domain OFDM signal is transmitted through an antenna port.

As illustrated in FIG. 2 and FIG. 3, the positioning reference signal pattern for a subframe and one Resource Block in the frequency axis is repeatedly copied and transmitted with the same pattern for the system bandwidth for the positioning reference signals in the frequency axis. In the time axis, the positioning reference signal pattern is transmitted through consecutive 1, 2, 4, or 6 subframes with a particular offset at a period of, for example, 160 ms (160subframe), 320 ms (320subframe), 640 ms (640subframe) or 1280 ms (1280subframe). The bandwidth for positioning reference signals in the frequency axis, and the period and the offset of subframes for transmission of positioning reference signals, and the number of consecutive subframes for transmission of positioning reference signals in the time axis in each BS 20 are controlled by a high layer, and this information is transmitted to each UE 10 through a Radio Resource Controller (RRC).

Herein, a cell specific subframe configuration period, T_{PRS}, for transmission of positioning reference signals may be 160, 320, 640, or 1280 subframes, and a cell specific subframe offset may be [I_{PRS}], [I_{PRS}-160], [I_{PRS}-480], [I_{PRS}-1120]. The PRS configuration index I_{PRS} can be determined by a high layer.

The positioning reference signals used for measurement of a user's position can be transmitted during a time. For measuring a more exact position, during a specified given time, either a time varying pattern transmission or a time non-varying pattern transmission may be performed. For example, if one subframe is the minimum unit for transmitting the positioning reference signal, the positioning reference signals may be transmitted over 2, 3, 4 . . . N subframes. At this time, the same positioning reference signal pattern is transmitted in each subframe in the case of time non-varying pattern transmission, and different positioning reference signal patterns are transmitted in the case of time varying pattern transmission.

Specifically, when the PRS patterns are cyclic-shifted along the frequency axis as shown in FIG. 2 and FIG. 3, the number of PRS patterns determinable from each other is six. Then, the BSs 20 can be divided into a total of six groups and the PRSs can be transmitted with six different PRS patterns. However, when taking the BSs 20 up to tier 2 into consideration based on the UE 10, there are BSs 20 corresponding to 19 cell sites or 57 cells (based on an assumption that only the BSs 20 up to tier 2 are BSs, from which the PRSs can be actually received, since PRSs transmitted from BSs above tier 2 are weak when they are received by a corresponding UE). Therefore, only the six PRS patterns are insufficient for transmission of PRSs having different patterns for every BS up to tier 2 and cannot avoid an existence of multiple BSs 20 having the same PRS pattern, which may cause performance degradation due to an interference between BSs in PRS transmission.

In the case of transmitting PRSs during more than a minimum time unit, that is, in the case of transmitting PRSs during more than one subframe as in the example described above, it is possible to either transmit the PRSs over every predetermined N subframe or mute transmission of the PRSs by a particular BS 20 in order to improve the performance by reducing an interference between BSs in the PRS transmission.

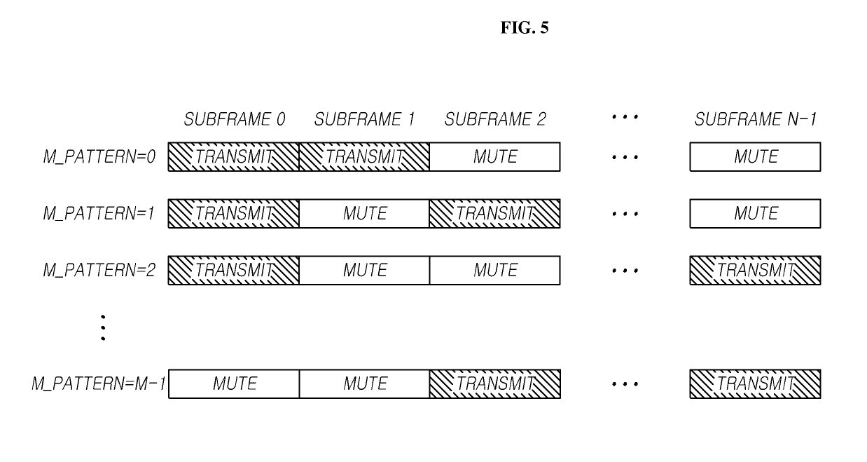

FIG. 5 illustrates a method of transmitting PRSs in muting patterns for N and K according to an exemplary embodiment of the present invention

Referring to FIG. 5, in transmitting positioning reference signals during 0 or N−1 subframes, the subframes are divided into “Transmit” subframe intervals, in which positioning reference signal are transmitted, and “Mute” subframe intervals, in which positioning reference signals are not transmitted.

Further, the time for transmission of PRSs by each BS is divided once more subframe by subframe, so as to further identify BSs transmitting the PRSs with the same PRS pattern. As a result, in the case of considering regional characteristics of BSs and effects of interference between BSs, it is possible to achieve a better performance than the method of transmitting positioning reference signals in all subframes.

Aspects of the present invention provide a transmission method according to a muting pattern determined by using a time offset (cyclic shift), in which the PRS is transmitted in a particular subframe and is not transmitted in another particular subframe, in order to achieve measurement of a more exact position of a UE.

Aspects of the present invention provide a method for constructing and transmitting a Positioning Reference Signal (PRS), which is a reference signal or pilot signal for location estimation of a UE, in a resource allocation structure for data transmission in a wireless communication system.

Aspects of the present invention provide a method for transmitting cell-specific numbers and PRSs having excellent performance, for more exact location estimation required by the development of communication, such as increasing moving speed of the UE, change of interference between BSs, and increasing complexity.

Aspects of the present invention provide a muting method in which the PRS is transmitted in a particular subframe and is not transmitted in another particular subframe. Further, aspects of the present invention provide a muting method, which can reduce the interference between PRSs transmitted to BSs, can be constructed in a simple and equal manner in all considerable transmission methods, and requires less assistant data from a higher layer in order to improve the exactness in measurement of a position of a UE.

As described above, the positioning reference signals are transmitted repeatedly with a specific period. For example, the positioning reference signals are transmitted in consecutive 1, 2, 4, or 6 subframes with the period of, for example, 160 ms (160 subframes), 320 ms (320 subframes), 640 ms (640 subframes) or 1280 ms (1280 subframes). At this time, the bandwidth for positioning reference signals from each BS 20, the period of subframes in the time axis, offset, and the number of consecutive subframes being transmitted are controlled by a high layer, and such information is transmitted to each UE 10 by the RRC (Radio Resource Controller). Such information is included in Tables 1 and 2.

Table 1 shows assistance data associated with a serving cell.

As noted from Table 1, the assistance data related to the serving cell includes bandwidth for positioning reference signals, positioning reference signals configuration index, and number of consecutive downlink subframes, N_{PRS}.

TABLE 1

| Information | Size (bits) | Explanation |
|---|---|---|
| Bandwidth for | [X] | The bandwidth that is used to |
| positioning | | conFIG. the positioning reference |
| reference signals | | signals on. |
| N_{RB}^{PRS} | | |
| Positioning | [12] | ConFIG.s the periodicity and |
| reference signals | | offset of the subframes with |
| configuration Index | | positioning reference signals. |
| I_{PRS} | | For example, periodicities of 160, |
| | | 320, 640, or 1280 subframes |
| Number of | [2] | ConFIG.s number of consecutive |
| consecutive | | downlink subframes with |
| downlink subframes | | positioning reference signals. |
| N_{PRS} | | For example, 1, 2, 4, or 6 |
| | | consecutive subframes |

Table 2 also shows assistance data associated with measured cells as assistant data for positioning.

As noted from Table 2, the assistant data related to the measured cell includes PCI, Timing offset, normal or extended CP, Antenna port configuration, Slot number offset, and Muting offset.

Aspects of the present invention additionally employ a new Muting Offset (cyclic shift), so that a user can see information regarding Muting Offset of the measured cell.

TABLE 2

| | Size (bits) | |
|---|---|---|
| Information | per cell | Explanation |
| PCI N_{ID}^{cell} | 9 | The PCI for each cell that the UE |
| | | should measure on. |
| Timing offset | [X] | The transmit timing offset |
| | | between the serving cell and the |
| | | measured cell. |
| Normal or extended | 1 bit per | 1 bit per measured cell, indicating |
| CP N_{CP} | measured | positioning reference signals with |
| | cell, or 1 bit | normal or extended cyclic prefix. |
| | | 1 bit, indicating that all measured |
| | | cells have the same length of the |
| | | CP as the serving cell |
| Antenna port | 1 bit per | 1 bit per measured cell, indicating |
| configuration | measured | 1 (or 2) antenna port(s) or 4 |
| | cell, or 1 bit | antenna ports for cell specific |
| | | reference signals |
| | | 1 bit, indicating that all measured |
| | | cells transmits cell specific |
| | | reference signals on the “same” |
| | | antenna port(s) as the serving cell. |
| | | Here, 1 and 2 antenna ports are |
| | | regarded as the “same”. |
| Slot number offset | 5 bits per | 5 bits per measured cell, |
| nₛ | measured | indicating the slot number offset |
| | cell, or 1 bit | between the serving cell and the |
| | | measured cell. |
| | | 1 bit, indicating that all measured |
| | | cells has the same slot timing as |
| | | the serving cell. |
| Muting offset | 1 to 3 bit per | 1 to 3 bits per measured cell, |
| (cyclic shift) nₘ | measured | indicating the muting offset (cyclic |
| | cell | shift) between the serving cell and |
| | | the measured cell or muting offset |
| | | pattern group |

Aspects of the present invention provide a muting offset (cyclic shift) nₘ as shown in Table 2.

The muting offset may have one to three bits per measured cell, and indicates how many bits a cell group has as the muting offset. That is to say, the muting offset refers to a muting offset (cyclic shift) between the serving cell and a measured cell or a muting offset pattern group.

Hereinafter, values, which the muting offset may have, will be described with reference to Tables 3 to 5. NPRS in Tables 3 to 5 corresponds to the number of consecutive downlink subframes having positioning reference signals.

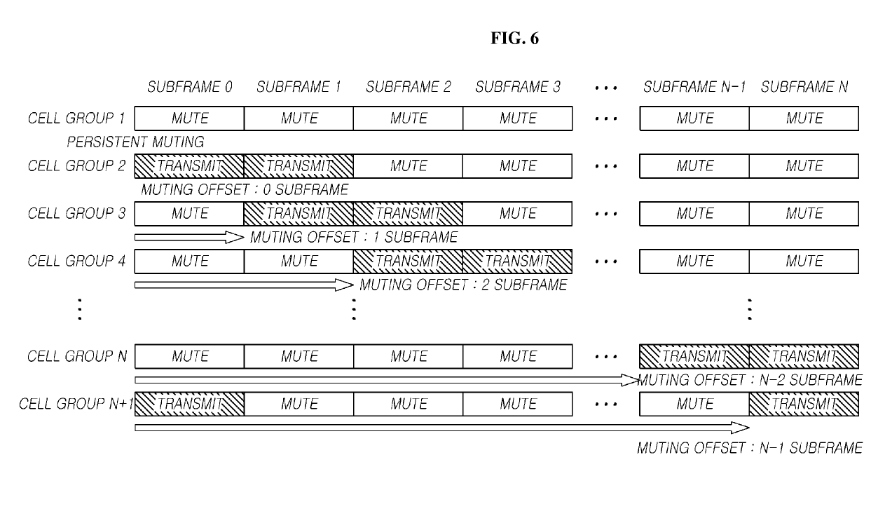

Referring to FIG. 6, regarding N (for example, N=1, 2, 4, or 6) consecutive subframes assigned in order to transmit positioning reference signals with a period (for example, 160 ms, 320 ms, 640 ms, or 1280 ms; one subframe corresponds to 1 ms), each BS (or cell group) 20 transmits positioning reference signals in K (i.e., 2) subframes among the N subframes, while muting the (N-K) subframes, i.e., (N−2) subframes, without transmitting any positioning reference signal in the (N-K) subframes.

The cell groups are divided into (N+1) cell groups, and the positioning reference signals are transmitted with different muting patterns according to the (N+1) cell groups. For example, cell group #1 is mute without transmission of a positioning reference signal in all of the N subframes allocated for the transmission of the positioning reference signals during a period (or, in other words, transmits the positioning reference signals with a power of 0). Cell group #2 transmits positioning reference signals in the first and second subframes among the N subframes, while muting without transmission of a positioning reference signal in the remaining subframes. Cell group #3 transmits positioning reference signals in the second and third subframes among the N subframes allocated for transmission of the positioning reference signals during the period with a muting offset of 1, while muting without transmission of a positioning reference signal in the remaining subframes. In the same way, cell group #N transmits positioning reference signals in the (N−1)th and Nth subframes among the N subframes allocated for transmission of the positioning reference signals during the period with a muting offset of (N−2), while muting without transmission of a positioning reference signal in the remaining subframes. Finally, cell group #(N+1) transmits positioning reference signals in the Nth and first subframes among the N subframes allocated for transmission of the positioning reference signals during the period with a muting offset of (N−1), while muting without transmission of a positioning reference signal in the remaining subframes. As noted from the final cell group, i.e., cell group #(N+1), the muting offset returns to the first subframe after the cyclic-shifting through the N subframes allocated for transmission of the PRSs.

TABLE 3

| Value | Offset (Cyclic shift) |
|---|---|
| 000 | Persistent muting cell group |
| 001 | 0 subframe |
| 010 | 1 subframe |
| 011 | 2 subframe |
| 100 | 3 subframe |
| 101 | 4 subframe |
| 110 | 5 subframe |
| 111 | reserved |

Table 3 shows values of the muting offset determined by three bits. The three bit muting offset can express up to N N_{PRS}=6 in the muting pattern as shown in FIG. 6. That is to say, because of N=6 and K=2 (PRSs are transmitted by two subframes among the six subframes), the cell groups are divided into a total of seven cell groups, which can be identified in sequence by “000” to “110”, i.e., by the three bits.

Since the muting offset values as determined by the three bits, when N_{PRS}=6, seven muting patterns exist and the number of BSs 20 determinable by time and frequency are 6 according to different positioning reference signal patterns. Therefore, it is possible to identify 42 BSs.

In addition, the number, M, corresponds to the number of all the cell groups including the persistent muting cell groups. The persistent muting cell groups mute without transmission of PRSs in the N subframes allocated for transmission of the positioning reference signals during a period. The number M of cell groups, the number of cells in each cell group, and the number K, which indicates the length of the consecutive subframes transmitting the PRSs without muting among the entire N subframes allocated for transmission of the PRSs, can be determined by the BS 20 or core network.

The above-described method can identify more cell groups and generate more muting patterns. The above-described method determines the muting offset by three bits, as shown in Table 3. Further, the muting offset increases by the value of “1” and both cell group #i (i indicates a natural number smaller than (N+1)) and cell group #(i+1) transmit PRSs in the i^{th} subframe. For example, both cell group #2 and cell group #3 transmit PRSs in the second subframe.

TABLE 4

| Value | Offset |
|---|---|
| 00 | Persistent muting cell group |
| 01 | 0 subframe |
| 10 | N_{PRS}/2 subframe |
| 11 | reserved |

Table 4 shows a method for expressing the muting offset in two bits. Referring to Table 4, the muting offset value of “00” corresponds to a persistent muting cell group, which is mute without transmission of a positioning reference signal in all the N subframes allocated for the transmission of the positioning reference signals during a period. The muting offset value of “01” corresponds to a cell group, which has a muting offset of 0 and transmits positioning reference signals in K subframes of the front side among N subframes, while muting the remaining (N-K) subframes after the K subframes without transmitting any positioning reference signal in the remaining (N-K) subframes. The muting offset value of “10” corresponds to a cell group having a muting offset of NPRS/2 and that transmits positioning reference signals in K subframes from the (NPRS/2)th subframe among N subframes, while muting the remaining (N-K) subframes without transmitting any positioning reference signal in the (N-K) subframes.

As described above, in this method, the cell groups are bundled into three groups and the values for the muting offset are expressed by two bits. Therefore, it is possible to decrease the information bits for expressing the muting offset and to decrease any interference from another cell group.

Since the cell groups are bundled into three groups by the muting offset and the number of BSs 20 identifiable according to the time and frequency is six according to the different PRS patterns, it is possible to identify a total of 18 BSs 20.

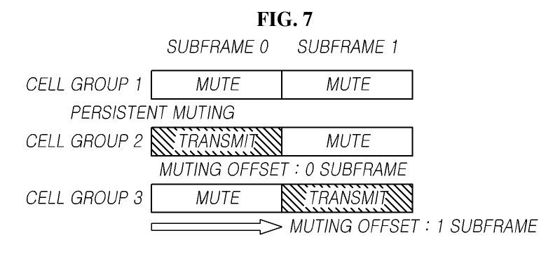

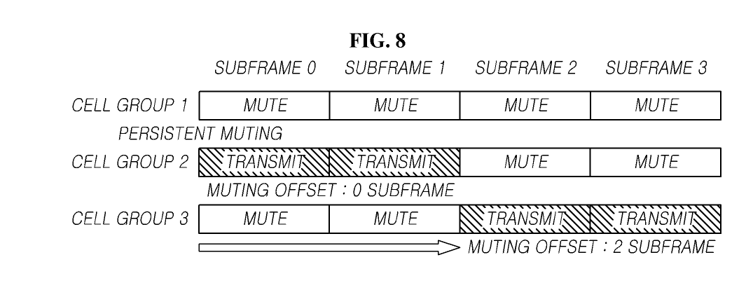

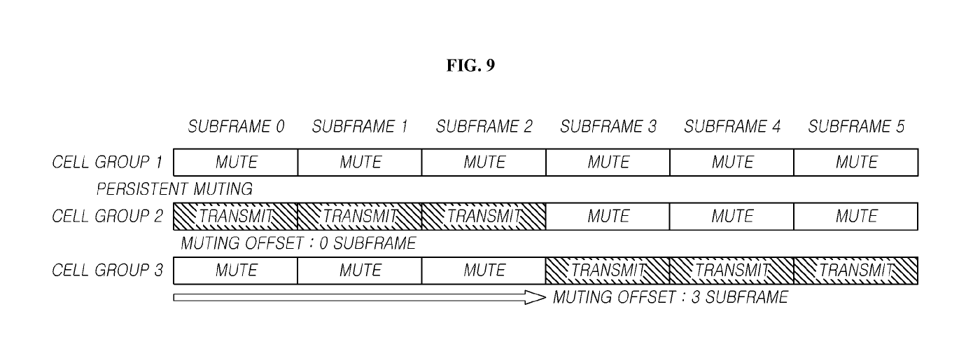

Hereinafter, muting patterns, in which the muting offset is expressed by two bits and the cell groups are bundled into three groups as shown in Table 4 when the number NPRS of downlink subframes for the positioning reference signals are 2, 4, and 6, respectively, will be described with reference to FIG. 7. FIG. 8, and FIG. 9.

FIG. 7 illustrates muting patterns, in which the cell groups are bundled into three cell groups, and the number NPRS of downlink subframes for the positioning reference signals is 2.

Referring to FIG. 7, the number NPRS of downlink subframes for the positioning reference signals is 2, and the number K of consecutive PRS subframes for transmitting the positioning reference signals is 1.

From among two consecutive subframes allocated for transmitting positioning reference signals with a period (for example, 160 ms, 320 ms, 640 ms, or 1280 ms; one subframe corresponds to 1 ms), some BS groups transmit PRSs in one subframe while muting the remaining subframe without transmission of PRSs therein.

Cell group #1 is mute without transmission of a positioning reference signal in both of the two subframes allocated for the transmission of the positioning reference signals during a period (or, in other words, transmits the positioning reference signals with a power of 0). Cell group #2 has a muting offset of 0 and transmits positioning reference signals in the first subframe (subframe #0) among the two subframes allocated for the transmission of the positioning reference signals during the period, while muting without transmission of a positioning reference signal in the remaining subframe. Cell group #3 has a muting offset of NPRS/2 (=2/2=1) and transmits positioning reference signals in the second subframe (subframe #1) among the two subframes allocated for the transmission of the positioning reference signals during the period, while muting without transmission of a positioning reference signal in the remaining subframes.

The number M of cell groups, the number of cells in each cell group, and the length K of the consecutive PRS subframes allocated for transmission of the PRSs during the period can be selected by the BS 20 or core network.

FIG. 8 illustrates muting patterns in which the cell groups are bundled into three cell groups, and the number NPRS of downlink subframes for the positioning reference signals is 4.

Referring to FIG. 8, the number NPRS of downlink subframes for the positioning reference signals is 4, and the number K of consecutive PRS subframes for transmitting the positioning reference signals is 2.

From among four consecutive subframes allocated for transmitting positioning reference signals with a period (for example, 160 ms, 320 ms, 640 ms, or 1280 ms; one subframe corresponds to 1 ms), some BS groups transmit PRSs in two subframes while muting the remaining subframes without transmission of PRSs therein.

Cell group #1 is persistently mute without transmission of a positioning reference signal in all of the four subframes allocated for the transmission of the positioning reference signals during a period (or, for example, transmits the positioning reference signals with a power of 0). Cell group #2 has a muting offset of 0 and transmits positioning reference signals in the first and second subframes (subframe #0 and subframe #1) among the four subframes allocated for the transmission of the positioning reference signals during a predetermined period, while muting without transmission of a positioning reference signal in the remaining subframes. Cell group #3 has a muting offset of NPRS/2 (=4/2=2) and transmits positioning reference signals in the third and fourth subframes (subframe #2 and subframe #3) among the four subframes allocated for the transmission of the positioning reference signals during a predetermined period, while muting without transmission of a positioning reference signal in the remaining subframes.

The number of cell groups, the number of cells in each cell group, and the length of the consecutive PRS subframes allocated for transmission of the PRSs during the period can be selected by the BS 20 or core network.

FIG. 9 illustrates muting patterns in which the cell groups are bundled into three cell groups, and the number NPRS of downlink subframes for the positioning reference signals is 6.

Referring to FIG. 9, the number NPRS of downlink subframes for the positioning reference signals is 6, and the number K of consecutive PRS subframes for transmitting the positioning reference signals is 3.

From among six consecutive subframes allocated for transmitting positioning reference signals with a period (for example, 160 ms, 320 ms, 640 ms, or 1280 ms; one subframe corresponds to 1 ms), some BS groups transmit PRSs in three subframes while muting the remaining three subframes without transmission of PRSs therein.

Cell group #1 persistently mutes without transmission of a positioning reference signal in all of the six subframes allocated for the transmission of the positioning reference signals during a period (or, for example, transmits the positioning reference signals with a power of 0). Cell group #2 has a muting offset of 0 and transmits positioning reference signals in the first, second, and third subframes among the six subframes allocated for the transmission of the positioning reference signals during the period, while muting without transmission of a positioning reference signal in the remaining subframes. Cell group #3 has a muting offset of NPRS/2 (=6/2=3) and transmits positioning reference signals in the fourth, fifth, and sixth subframes among the six subframes allocated for the transmission of the positioning reference signals during a predetermined period, while muting without transmission of a positioning reference signal in the remaining subframes.

The number of cell groups, the number of cells in each cell group, and the length of the consecutive PRS subframes allocated for transmission of the PRSs during the period can be selected by the BS 20 or core network.

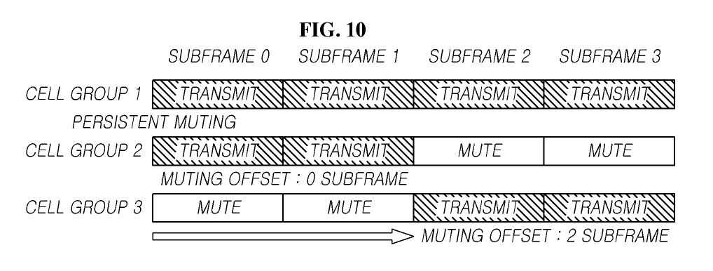

FIG. 10 illustrates muting patterns, in which the cell groups are bundled into three cell groups, and the number NPRS of downlink subframes for the positioning reference signals is 4.

Referring to FIG. 10, the number NPRS of downlink subframes for the positioning reference signals is 4, and the number K of consecutive PRS subframes for transmitting the positioning reference signals is 2.

From among four consecutive subframes allocated for transmitting positioning reference signals with a period (for example, 160 ms, 320 ms, 640 ms, or 1280 ms; one subframe corresponds to 1 ms), some BS groups transmit PRSs in two subframes while muting the remaining subframes without transmission of PRSs therein.

Cell group #1 persistently transmits positioning reference signals in all of the four subframes allocated for the transmission of the positioning reference signals during a period. Cell group #2 has a muting offset of 0 and transmits positioning reference signals in the first and second subframes (subframe #0 and subframe #1) among the four subframes allocated for the transmission of the positioning reference signals during the period, while muting without transmission of a positioning reference signal in the remaining subframes (subframe #2 and subframe #3). Cell group #3 has a muting offset of NPRS/2 (=4/2=2) and transmits positioning reference signals in the third and fourth subframes (subframe #2 and subframe #3) among the four subframes allocated for the transmission of the positioning reference signals during the period, while muting without transmission of a positioning reference signal in the remaining subframes (subframe #0 and subframe #1).

The number of cell groups, the number of cells in each cell group, and the length of the consecutive PRS subframes allocated for transmission of the PRSs during the period can be selected by the BS 20 or core network.

TABLE 5

| Value | Offset |
|---|---|
| 0 | 0 subframe |
| 1 | N_{PRS}/2 subframe |

Table 5 is a table expressing the muting offset by one bit according to a method for transmitting information of persistent muting cells, which are mute without transmission of PRSs in the N subframes allocated for transmission of the positioning reference signals during a period.

The information bit is set to have a variable length. That is, the persistent muting cells, which are mute without transmission of PRSs in the N subframes allocated for transmission of the positioning reference signals during the period, can be identified by removing the muting offset (cyclic shift) field since the muting offset information for the persistent muting cells is not transmitted. Then, as shown in Table 5, it is possible to discriminate two cell groups each including a muting offset field by only one bit.

Referring to Table 5, when there is no muting offset field, it implies a muting cell group, which is mute without transmission of PRSs (or transmits the PRSs with a power of 0) in the N subframes allocated for transmission of the positioning reference signals during a period. The muting offset value of “0” corresponds to a cell group, which has a muting offset of 0 and transmits positioning reference signals in K subframes of the front side among N subframes, while muting the remaining (N-K) subframes after the K subframes without transmitting any positioning reference signal in the (N-K) subframes. The muting offset value of “1” corresponds to a cell group that has a muting offset of NPRS/2 and transmits positioning reference signals in K subframes from the (NPRS/2)th subframe among the N subframes, while muting the remaining (N-K) subframes without transmitting any positioning reference signal in the (N-K) subframes.

In the method of Table 5 described above, cells are bundled into three cell groups and the muting offset can be expressed by a value of one bit. Therefore, it is possible to decrease the information bits for expressing the muting offset and to decrease any interference from another cell group.

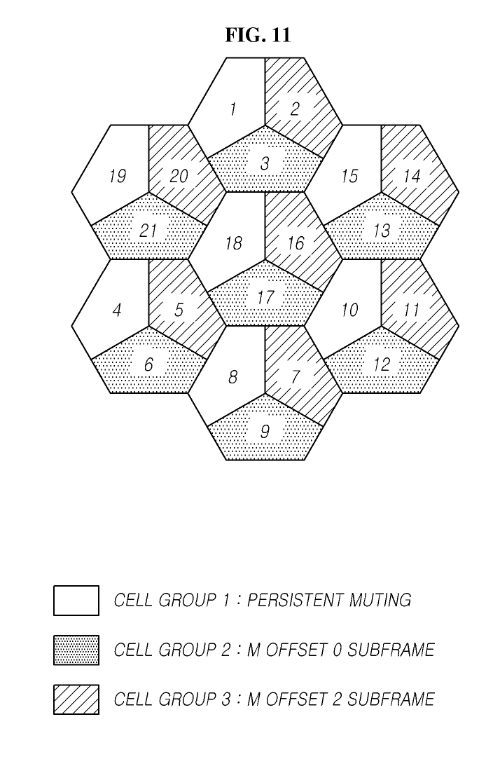

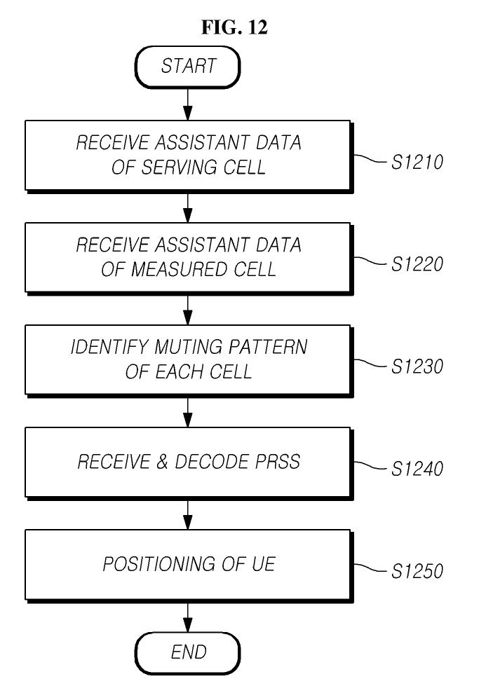

Hereinafter, an operation of a UE according to an exemplary embodiment of the present invention will be described with reference to FIG. 11 and FIG. 12, and Table 4.

FIG. 11 illustrates an arrangement of BSs (cells) divided into three groups according to the muting pattern for transmission of PRSs based, and FIG. 12 is a flowchart illustrating a method of positioning of a UE according to an exemplary embodiment of the present invention.

Referring to FIG. 12, first, a UE 10 for which a positioning thereof is to be determined receives assistant data or information as shown in Tables 1 and 2 from a serving cell (operation S1210). In Table 1, the UE 10 can obtain the bandwidth of PRSs from N_{RB}^{PRS} and the period and offset information of the PRSs from I_{PRS} wherein the offset information herein is different from the muting offset and indicates an offset for transmission of the PRSs in each period. Further, the UE 10 can obtain the number of downlink subframes allocated for transmission of the PRSs from N_{PRS}.

As described above, one, two, four, or six sub-frames are allocated as consecutive subframes for transmitting PRSs. In operation S1220, the UE 10 receives assistant data or information related to measured cells indicated in Table 2. In the received assistant data related to a measured cell, the UE 10 obtains a cell identifier (ID) of the measured cell from PCI N_{ID}^{cell}. Although the other parameters may also be necessary for the positioning, they are not described in detail since they have no direct relation to the present exemplary embodiment. Finally, the UE 10 can obtain muting offset information of the measured cell from the muting offset (cyclic shift) nₘ. Upon obtaining all the information of Table 2, the UE 10 can determine the muting cell groups to which each of the measured cells belongs, and determine the muting pattern by which the PRSs are transmitted.

When the muting offset has a value of two bits as in Table 4, it is possible to arrange an environment in which information bits are constructed as shown in Table 6 below.

TABLE 6

| PCI N_{ID}^{cell} | Muting | |
|---|---|---|
| (measured | offset (cyclic | |
| cell) | shift) nₘ | Cell group |
| 1 | 00 | Cell group 1 |
| 2 | 01 | Cell group 2 |
| 3 | 10 | Cell group 3 |
| 4 | 00 | Cell group 1 |
| 5 | 01 | Cell group 2 |
| 6 | 10 | Cell group 3 |
| 7 | 01 | Cell group 2 |
| 8 | 00 | Cell group 1 |
| 9 | 10 | Cell group 3 |
| 10 | 00 | Cell group 1 |
| 11 | 01 | Cell group 2 |
| 12 | 10 | Cell group 3 |
| 13 | 10 | Cell group 3 |
| 14 | 01 | Cell group 2 |
| 15 | 00 | Cell group 1 |
| 16 | 01 | Cell group 2 |
| 17 | 10 | Cell group 3 |
| 18 | 00 | Cell group 1 |
| 19 | 00 | Cell group 1 |
| 20 | 01 | Cell group 2 |
| 21 | 10 | Cell group 3 |

The assistant data in Table 6 corresponds to information, which is given to a UE 10 for which a positioning thereof is determined in a cell deployment environment as shown in FIG. 11. As noted from Table 6, the cell group division according to the muting pattern enables an allocation and arrangement of the cells or BSs, which can reduce the occurrence of interference in the BS 20 or core network.

Upon receiving the information, the UE 10 can identify the muting cell groups of the measured cells including the serving cell and identify the muting pattern of each cell (operation S1230). After identifying the muting pattern of each cell, the UE 10 can decode the PRSs and use them for the positioning according to a general positioning method (operation S1240).

The UE 10 receives PRSs having different PRS patterns and different muting patterns from at least three different BSs 20 and decodes the PRSs. For example, as shown in FIG. 11, the UE 10 receives PRSs having different PRS patterns and different muting patterns from cell #1, cell #2, and cell #3 belonging to cell group #1, cell group #2, and cell group #3, and decodes the PRSs.

According to the OTDOA (Observed Time Difference of Arrival) method, the UE 10 estimates the distance from each BS 20 by using the received relative arrival times from the at least three BSs 20. Then, the UE 10 estimates the position of itself through a triangulation (operation S1250).

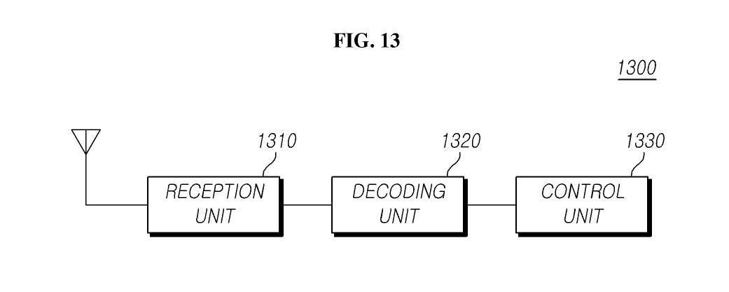

FIG. 13 is a block diagram illustrating a signal receiving apparatus of a UE according to an exemplary embodiment of the present invention.

The signal receiving apparatus 1300 of a UE 10 includes a reception unit 1310, a decoding unit 1320, and a control unit 1330.

The reception unit 1310 receives assistant data or information of a serving cell as shown in Tables 1 and 2 and assistant data or information of measured cells as shown in Table 2 from the serving cell. Then, from the received assistant data or information of the serving cell and measured cells, the reception unit 1310 can identify the muting cell groups, to which the serving cell and measured cells belong, and can identify the muting pattern of each cell. The reception unit 1310 receives PRSs having different PRS patterns and different muting patterns from three or more different BSs 20.

After identification of the muting pattern of each cell, the decoding unit 1320 decodes the PRSs according to a general positioning method. The decoding unit 1320 decodes the PRSs having different PRS patterns and different muting patterns, which have been received from three or more different BSs 20 by the reception unit 1310.

According to the OTDOA (Observed Time Difference of Arrival) method, the control unit 1330 estimates the distance from each BS 20 by using the relative arrival times of the PRSs from the three or more different BSs 20, which have been decoded by the decoding unit 1320. Then, the control unit 1330 estimates the position of the UE 10 through a triangulation

Hereinafter, a positioning operation of the signal receiving apparatus 1300 of the UE 10 will be described.

The reception unit 1310 converts signals received through antenna ports to complex time domain signals. Further, the reception unit 1310 extracts PRSs of particular resource elements from the received signals by using the PRS pattern and muting pattern. The decoding unit 1320 decodes the extracted PRSs. The control unit 1330 measures distances from BSs 20 by using relative arrival times from the BSs 20 through the decoded PRSs. At this time, instead of calculating, by the control unit 1330 itself, the distances from BSs 20 by using the relative arrival times from the BSs 20, the control unit 1330 may transmit the relative arrival times to the BSs 20 so that the BSs 20 may calculate the distances. Then, since the distances from at least three BSs are measured, it is possible to calculate the position of the UE 10.

The signal receiving apparatus 1300 described above is a counterpart of the transmission apparatus 400 of the wireless communication system described above with reference to FIG. 4 and receives a signal transmitted from the transmission apparatus 400. The signal receiving apparatus 1300 includes elements for a signal processing opposite to the signal processing by the transmission apparatus 400. Therefore, it should be understood that elements of the signal receiving apparatus 1300 not described in detail can be replaced by corresponding elements for a signal processing opposite to the signal processing by the transmission apparatus 400, respectively.

Meanwhile, allocation of muting cell groups as shown in Table 6 may be performed either to decrease interference in the BS 20 or core network as described above or according to groups obtained by dividing the cells through a modulo operation of the PCIs (Physical Cell IDs).

As described above with reference to Tables 3 to 6, it is possible to define the muting offset nₘ, by tabular bit values corresponding to specific cases, respectively. However, a method of commonly defining the muting offset in the same manner for all the cases shown in FIGS. 6 to 10 will now be described.

From among M cell groups, a muting offset of the i^{th} cell group can be defined by Equation (6) below.

Muting offset=(i−1)·└N_{PRS}/(M−1)┘ for 1≦i≦M−1 (6)

In Equation (6), a case in which i=0 corresponds to a persistent muting cell group, which mutes without transmitting a PRS in all N subframes allocated for transmission of PRSs during a period, or a persistent transmitting cell group, which transmits PRSs in all N subframes.

At this time, assistant data for an additionally given muting offset nₘ has a size of a total of ┌log₂ M┐ bits. Further, from among 2^{┌log}^{₂}^{M┐} values, which can be expressed by the ┌log₂ M┐ bits, M binary values from 0 to (M−1) are used while the other values are reserved. At this time, each of the M binary values expresses the ith cell group.

For example, in FIG. 2, if NPRS=6, M=7. Then, cell group #i is defined by values of i from 0 to 6, and assistance data for the muting offset nₘ can be expressed by three bit values as shown in Table 7. The muting offset values according to the values of i in Table 7 can be determined from Equation (6). As shown, Table 7 corresponds to a general expression of Table 3.

TABLE 7

| Value | Cell group i | Offset (Cyclic shift) |
|---|---|---|
| 000 | i = 0 | Persistent muting cell group |
| 001 | i = 1 | Offset = 0 subframe |
| 010 | i = 2 | Offset = 1 subframe |
| 011 | i = 3 | Offset = 2 subframe |
| 100 | i = 4 | Offset = 3 subframe |
| 101 | i = 5 | Offset = 4 subframe |
| 110 | i = 6 | Offset = 5 subframe |
| 111 | Reserved | |

The values, which the muting offset may have, are expressed by three bits. Therefore, when NPRS=6, it is possible to identify 42 base stations since there are seven muting patterns and the number of base stations determinable by time and frequency are 6 according to different positioning reference signal patterns.

Further, in the example shown in FIGS. 7 to 9, NPRS is 2 4, or 6, and cell group #i is defined by a value of 0 to 2 when M=3. Moreover, as shown in Table 8 below, assistance data for the muting offset nₘ can be expressed by two bits. In table 8, the muting offset values according to i can also be determined from Equation (6). As shown, Table 8 serves as a general expression of Table 4.

TABLE 8

| Value | Cell group i | Offset (Cyclic shift) |
|---|---|---|
| 00 | i = 0 | Persistent muting (or transmitting) cell |
| | | group |
| 01 | i = 1 | Offset = 0 subframe |
| 10 | i = 2 | Offset = └N_{PRS}/2┘ subframe |
| 11 | reserved | |

By calculating the muting offset by using Equation (6) described above, it is possible to generally define the muting offset in the same manner regardless of the number NPRS of consecutive subframes allocated for the PRSs, the number M of all cell groups, and the length K of consecutive PRS subframes used for transmission without muting from among the NPRS consecutive subframes, and it is unnecessary to separately arrange a table for defining the muting offset for each case.

In the above-described methods, a persistent transmitting cell group transmitting PRSs may be taken into consideration instead of the persistent muting cell group.

By a method of transmitting PRSs using a more effective and efficient muting method according to aspects of the present invention, it is possible to reduce interference, which may be caused when multiple base stations 20 simultaneously transmit the same PRS pattern as in the conventional muting method. In addition, according to aspects of the present invention, it is possible to employ a muting method in a simple and equal manner regardless of subframes consecutively used during a period.

Further, in measuring the position of a UE 10 based on an estimation of difference between arrival times of PRSs received and demodulated by the UE 10, the muting method is effective in that it decreases assistance data from a higher layer in order to identify the muting pattern of PRSs transmitted from each BS 20. Therefore, it is possible to use the transmitted PRSs more effectively and efficiently.

Moreover, by implementing the muting pattern by using the muting offset, it is possible to implement the muting pattern while decreasing complexity thereof.

Although the embodiments described above are based on the drawings, aspects of the present invention are not limited to the described and illustrated embodiments. For example, in the muting offset, in which positioning reference signals are transmitted in K subframes among N subframes while the remaining (N-K) subframes are mute without transmission of any positioning reference signal, the K subframes may correspond to either subframes from the first subframe to the Kth subframe with a time offset of a subframe, or subframes from a subframe of another group with a time offset of one subframe.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for signal communication of a wireless communication system, the method comprising:
allocating N consecutive downlink subframes for a positioning reference signal (PRS) to each period of a plurality of periods for at least one base station, the PRS being allocated as large as a PRS bandwidth of a total bandwidth;
by the at least one base station, transmitting the PRS or muting the PRS to a terminal in the N consecutive downlink subframes of at least one period of the plurality of periods;
by the terminal, receiving at least one of the transmitted PRS or the muted PRS from the at least one base station in the N consecutive downlink subframes of the at least one period of the plurality of periods; and
by the terminal, calculating at least one difference of arrival time of the transmitted PRS or the muted PRS from the at least one base station
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

2. The method of claim 1,
wherein the N consecutive downlink subframes comprise one of 2, 4, or 6 consecutive downlink subframes.

3. The method of claim 1, wherein each period comprises one of 160 ms, 320 ms, 640 ms, or 1280 ms.

4. The method of claim 1, wherein the transmitting or muting further comprises:
transmitting the PRS in the N consecutive downlink subframes or muting the PRS in the N consecutive downlink subframes according to a normal cyclic prefix length or an extended cyclic prefix length.

5. The method of claim 1, wherein the allocating further comprises:
allocating normal subframes configured for PRS transmission and multicast broadcast single frequency network (MBSFN) subframes configured for PRS transmission to the N consecutive downlink subframes.

6. The method of claim 1, wherein the PRS are not mapped to resource elements allocated to a physical broadcast channel (PBCH), a primary synchronization signal (PSS), or a secondary synchronization signal (SSS).

7. The method of claim 1, wherein the base station transmits a PRS according to a specific PRS pattern.

8. The method of claim 1, wherein the N, the PRS bandwidth, and the period of the at least one base station are configured by higher layer of the base station.

9. A method for signal transmission of a wireless communication system, the method comprising:
allocating N consecutive downlink subframes for a positioning reference signal (PRS) to each period of a plurality of periods for at least one base station, the PRS being allocated as large as a PRS bandwidth of a total bandwidth; and
by the at least one base station, transmitting the PRS or muting the PRS to a terminal in the N consecutive downlink subframes of at least one period of the plurality of periods;
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

10. The method of claim 9, wherein the N consecutive downlink subframes comprise one of 2, 4, or 6 consecutive downlink subframes.

11. The method of claim 9, wherein each period comprises one of 160 ms, 320 ms, 640 ms, or 1280 ms.

12. A method for signal receiving of a wireless communication system, the method comprising:
by the terminal, receiving at least one of a transmitted positioning reference signal (PRS) or a muted PRS in N consecutive downlink subframes of at least one period of a plurality of periods from at least one base station, the PRS being allocated as large as a PRS bandwidth of a total bandwidth; and
by the terminal, calculating at least one difference of arrival time of the transmitted PRS or the muted PRS from the at least one base station;
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

13. The method of claim 12, wherein the N consecutive downlink subframes comprise one of 2, 4, or 6 consecutive downlink subframes.

14. The method of claim 12, wherein each period comprises one of 160 ms, 320 ms, 640 ms, or 1280 ms.

15. A wireless communication system, comprising:
at least one base station to allocate N consecutive downlink subframes for a positioning reference signal (PRS) to each period of a plurality of periods for at least one base station, the PRS being allocated as large as a PRS bandwidth of a total bandwidth and transmit the PRS or muting the PRS to a terminal in the N consecutive downlink subframes of at least one period of the plurality of periods; and
the terminal to receive at least one of the transmitted PRS or the muted PRS from the at least one base station in the N consecutive downlink subframes of the at least one period of the plurality of periods; and calculate at least one difference of arrival time of the transmitted PRS or the muted PRS from the at least one base station,
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

16. The system of claim 15, wherein the N consecutive downlink subframes comprise one of 2, 4, or 6 consecutive downlink subframes.

17. The system of claim 15, wherein each period comprises one of 160 ms, 320 ms, 640 ms, or 1280 ms.

18. The system of claim 15, wherein the at least one base station further transmits the PRS in the N consecutive downlink subframes or muting the PRS in the N consecutive downlink subframes according to a normal cyclic prefix length or an extended cyclic prefix length.

19. The system of claim 15, wherein the at least one base station further allocates normal subframes configured for PRS transmission and multicast broadcast single frequency network (MBSFN) subframes configured for PRS transmission to the N consecutive downlink subframes.

20. The system of claim 15, wherein the PRS are not mapped to resource elements allocated to a physical broadcast channel (PBCH), a primary synchronization signal (PSS), or a secondary synchronization signal (SSS).

21. The system of claim 15, wherein the at least one base station 1 transmits a PRS according to a specific PRS pattern.

22. The method of claim 15, wherein the N, the PRS bandwidth, and the period of the at least one base station are configured by higher layer of the base station.

23. A signal transmission apparatus, comprising:
a resource element mapper to map complex modulation symbols of each antenna port to a corresponding resource element; and
a position reference signal (PRS) resource allocation unit to allocate N consecutive downlink subframes for a positioning reference signal (PRS) to each period of a plurality of periods for at least one base station, the PRS being allocated as large as a PRS bandwidth of a total bandwidth; and
transmit the PRS or muting the PRS to a terminal in the N consecutive downlink subframes of at least one period of the plurality of periods,
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

24. The signal transmission apparatus of claim 23, wherein the N consecutive downlink subframes comprise one of 2, 4, or 6 consecutive downlink subframes.

25. The signal transmission apparatus of claim 23, wherein each period comprises one of 160 ms, 320 ms, 640 ms, or 1280 ms.

26. A signal reception apparatus, comprising:
a reception processing unit to receive at least one of a transmitted positioning reference signal (PRS) or a muted PRS in N consecutive downlink subframes of at least one period of a plurality of periods from at least one base station, the PRS being allocated as large as a PRS bandwidth of a total bandwidth; and
a control unit calculate at least one difference of arrival time of the transmitted PRS or the muted PRS from the at least one base station,
wherein the N, the PRS bandwidth, and the period of the at least one base station are delivered to the terminal from the at least one base station; and
wherein transmitting the PRS or muting the PRS comprises transmitting all PRS or muting all PRS in the N consecutive downlink subframes of the at least one period of the plurality of periods.

27. The signal reception apparatus of claim 26, wherein the N consecutive downlink subframes comprise one of 2, 4, or 6 consecutive downlink subframes.

28. The signal reception apparatus of claim 26, wherein each period comprises one of 160 ms, 320 ms, 640 ms, or 1280 ms.
